(19) United States
(12) Patent Application Publication
(10) Pub. No.: US 2017/0072996 A1
(43) Pub. Date: Mar. 16, 2017

(54) APPARATUS AND METHOD FOR CONTROLLING ELECTRIC POWER STEERING SYSTEM

(71) Applicant: MANDO CORPORATION, Pyeongtaek-si (KR)

(72) Inventors: Seunggyu HONG, Bucheon-si (KR); Seongjoo KIM, Seongnam-si (KR)

(21) Appl. No.: 14/853,985

(22) Filed: Sep. 14, 2015

(51) Int. Cl. B62D 5/04

(52) U.S. Cl. CPC B62D 5/0463; B62D 5/049

(57) ABSTRACT

According to an embodiment of the present invention, an apparatus for controlling an electric power steering system includes a failure detection unit detecting whether a torque sensor has failed; a first calculation unit calculating an absolute steering angle based on information detected by a motor position sensor; and a second calculation unit calculating an estimated lateral acceleration of a vehicle based on the absolute steering angle calculated by the first calculation unit and velocity of the vehicle received from a velocity sensor, wherein, if a failure of a torque sensor is detected by the failure detection unit, an assist current value is applied to the motor based on the estimated lateral acceleration of the vehicle.

### BACKGROUND

1. Field of the Invention

The present invention relates to an apparatus and method for controlling an electric power steering system, and more particularly, to an apparatus and method for controlling an electric power steering system capable of performing restricted assist control if a failure of a torque sensor occurs.

2. Discussion of Related Art

Generally, an electric power steering (EPS) system is provided to lessen steering force applied to a steering handle by a driver when driving a vehicle at low velocity or parking a vehicle. However, an electric power steering system has a limitation in estimating a current torque value when a failure of a torque sensor occurs, thus having a limitation in stably controlling an attitude of a vehicle.

Meanwhile, recently, when a torque sensor has failed, a method of generating a virtual torque signal using a steering angle sensor and a motor position sensor, etc. and performing restricted assist control by the virtual torque signal has been suggested. However, the torque sensor and the steering angle sensor use a wire harness formed of one group, thereby being unable to stably control the electric power steering system if the whole wire harness is disconnected.

### SUMMARY OF THE INVENTION

According to an embodiment of the present invention, an object of an apparatus and method for controlling an electric power steering system is as follows.

The present invention is directed to providing an apparatus and method capable of controlling an electric power steering system so that a steering feeling of a driver does not become extremely heavy even if a torque sensor has failed in the electric power steering system.

The objects of the present invention is not limited to that mentioned above, and other unmentioned objects will be clearly understood by those of ordinary skill in the art by descriptions below.

According to an embodiment of the present invention, there is provided an apparatus for controlling an electric power steering system, the apparatus including: a failure detection unit detecting whether a torque sensor has failed; a first calculation unit calculating an absolute steering angle based on information detected by a motor position sensor; and a second calculation unit calculating an estimated lateral acceleration of a vehicle based on the absolute steering angle calculated by the first calculation unit and velocity of the vehicle received from a velocity sensor, wherein, if a failure of the torque sensor is detected by the failure detection unit, an assist current value is applied to the motor based on the estimated lateral acceleration of the vehicle.

The motor may include a rotor and a stator, and the motor position sensor may detect a relative angle between the rotor and the stator.

The estimated lateral acceleration of the vehicle may be calculated using a bicycle model

The apparatus may further include a validity determination unit determining validity of the estimated lateral acceleration by comparing the estimated lateral acceleration calculated by the second calculation unit with lateral acceleration information obtained from a lateral acceleration sensor mounted on the vehicle.

According to an embodiment of the present invention, there is provided a method for controlling an electric power steering system, the method including: detecting whether a torque sensor has failed; if it is determined that the torque sensor has failed, calculating an absolute steering angle based on information detected by a motor position sensor of the electric power steering system; calculating an estimated lateral acceleration of a vehicle based on the calculated absolute steering angle and velocity of the vehicle received from a velocity sensor; and applying an assist current value to the motor based on the estimated lateral acceleration.

The absolute steering angle may be a relative angle between the rotor and stator of the motor.

The estimated lateral acceleration of the vehicle may be calculated using a bicycle model.

The method may further include determining validity of the estimated lateral acceleration between the calculating of the estimated lateral acceleration and the applying of the assist current value to the motor.

The validity of the estimated lateral acceleration may be determined by comparing the estimated lateral acceleration with the lateral acceleration information obtained from a lateral acceleration sensor mounted on the vehicle.

According to an embodiment of the present invention, if a torque sensor in an electric power steering system has failed, an apparatus and method for controlling the electric power steering system apply an assist current value to a motor by an estimated lateral acceleration of a vehicle estimated based on an absolute steering angle of a motor and velocity of the vehicle, thereby stably controlling the electric power steering system even if a whole wire harness transmitting signals of the torque sensor and steering angle sensor is disconnected.

The advantages of the present invention are not limited to those mentioned above, and other unmentioned advantages will be clearly understood by those of ordinary skill in the art by descriptions below.

### BRIEF DESCRIPTION OF THE DRAWINGS

FIG. 1 is a block diagram of an apparatus for controlling an electric power steering system according to an embodiment of the present invention;

FIG. 2 is an illustrative drawing of a simplified bicycle model for calculating an estimated lateral acceleration in an apparatus for controlling an electric power steering system according to an embodiment of the present invention; and

FIG. 3 is a flow chart sequentially illustrating a method for controlling an electric power steering system according to an embodiment of the present invention.

### DETAILED DESCRIPTION OF EXEMPLARY EMBODIMENTS

Exemplary embodiments of the present invention will be described in detail below with reference to the accompanying drawings while like reference numerals will be given to like or similar elements regardless of symbols in the drawings and repeated explanation thereof will be omitted.

In addition, if a detailed description of the known art related to the present invention is deemed to make the gist of the present invention vague, the detailed description thereof will be omitted. In addition, the accompanying drawings are only intended to make the spirit of the present invention easier to understand, and the spirit of the present invention should not be construed as being limited by the accompanying drawings.

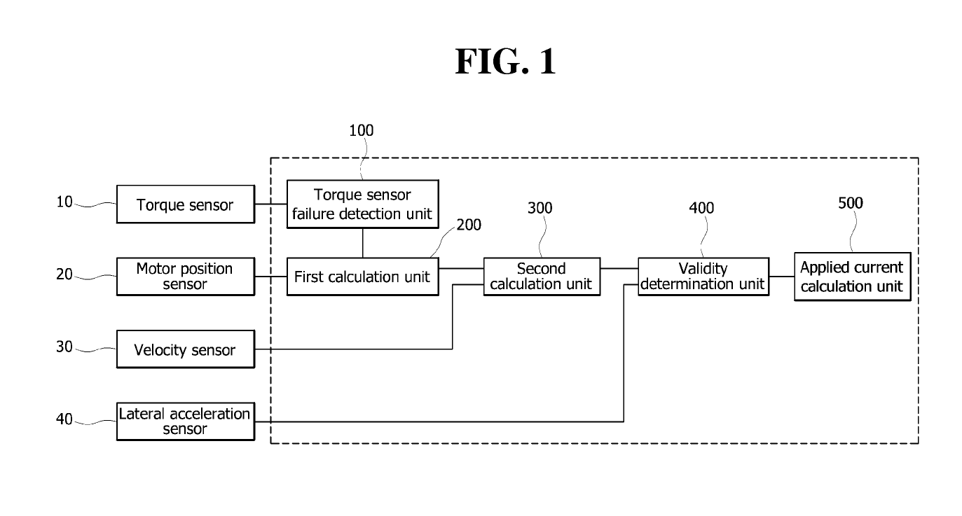

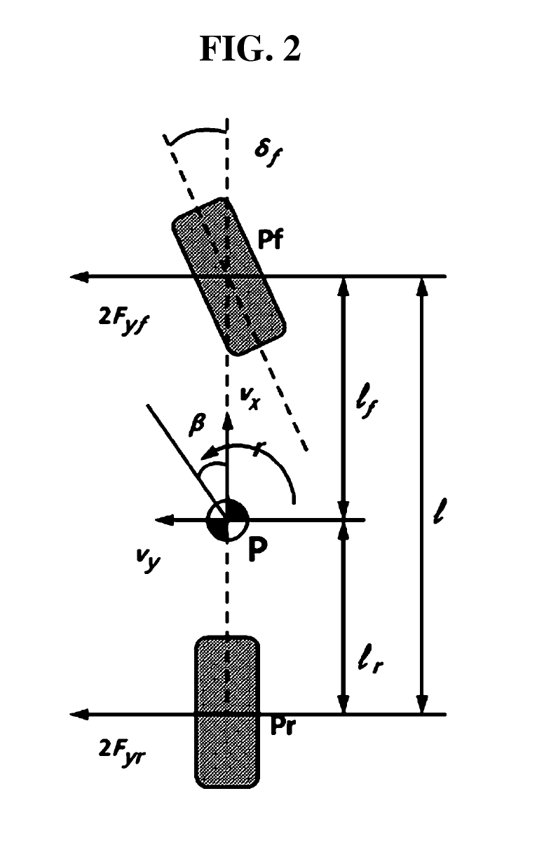

Hereinafter, a method for controlling an electric power steering system according to an embodiment of the present invention will be described with reference to FIG. 1 and FIG. 2. FIG. 1 is a block diagram of an apparatus for controlling an electric power steering system according to an embodiment of the present invention, and FIG. 2 is an illustrative drawing of a simplified bicycle model for calculating an estimated lateral acceleration in an apparatus for controlling an electric power steering system according to an embodiment of the present invention.

As depicted in FIG. 1, the apparatus for controlling the electric power steering system according to an embodiment of the present invention includes a torque sensor failure detection unit 100, a first calculation unit 200, a second calculation unit 300, etc.

The torque sensor failure detection unit 100 detects whether a torque sensor 10 has failed if an abnormality occurs in the torque sensor 10. If the failure detection unit 100 detects the failure of the torque sensor 10, the first calculation unit 200 first calculates an absolute steering angle based on information detected by a motor position sensor 20. Specifically, the motor position sensor 20 detects a relative angle between a rotor and a stator in a motor of an electric steering system for a vehicle, and the absolute steering angle is calculated based on the relative angle.

The second calculation unit 300 calculates an estimated lateral acceleration of the vehicle based on the absolute steering angle calculated by the first calculation unit 200 and velocity of the vehicle received from a velocity sensor 30.

As stated above, if the torque sensor has failed, the estimated lateral acceleration of the vehicle can be calculated without using steering angle information received from a steering angle sensor, thereby stably controlling the electric power steering system even if the whole wire harness transmitting the signals of the torque sensor and steering angle sensor is disconnected.

Meanwhile, the estimated lateral acceleration of the vehicle can be more easily and promptly calculated using a bicycle model, which will be described illustratively with reference to FIG. 2.

In one example, if a generally used, simplified bicycle model is used, δ_{f} in FIG. 2 refers to a steering angle (δ) or an angle (an angle related to a turn angle) corresponding to the steering angle (δ), P_{f} refers to the center of a front wheel, Pᵣ refers to the center of a rear wheel, l refers to a distance between the center of the front wheel (P_{f}) and the center of the rear wheel (Pᵣ), and P refers to a specific point on a segment connecting P_{f} to Pᵣ. Furthermore, l_{f} is a distance component from the center of the front wheel (P_{f}) to P, and lᵣ is a distance component from the center of the rear wheel (Pᵣ) to P.

In FIG. 2, when an x-axis direction (the direction of the segment connecting P_{f} to Pᵣ) is a front direction of a vehicle and a y-axis direction (the direction perpendicular to the segment connecting P_{f} to Pᵣ) is a lateral direction of the vehicle, vₓ refers to an x-axis velocity component of the vehicle and v_{y} refers to a y-axis velocity component of the vehicle. Consequently, velocity (V) of the vehicle can be obtained by the sum of vₓ and v_{y}.

In addition, with respect to the x-axis, a β component is an angle corresponding to a turn angle in an over steering state, and a γ value refers to an element corresponding to a yaw rate value having the point P as a central axis in the over steering state of the vehicle. 2F_{yf} indicates force received by the front wheel in the y-axis direction, and 2F_{yr} indicates force received by the rear wheel in the y-axis direction.

For example, a lateral acceleration with respect to velocity of a vehicle and a steering input can be estimated using the mathematical equation 1 below.

$${a}_{y} = \frac{\frac{{V}^{2}}{57.3 Lg}}{1 + \frac{{KV}^{2}}{57.3 Lg}} δ \qquad [ Mathematical Equation 1 ]$$

a_{y}: lateral acceleration

δ: steering angle

V: velocity of vehicle

L: wheelbase

K: under steer gradient (constant)

g: acceleration of gravity

More specifically, while knowing the information on the wheelbase (L), the Under Steer Gradient constant (K), and the acceleration of gravity (g) which are constants, the estimated lateral acceleration (a_{y}) of a vehicle can be calculated based on the velocity (V) information obtained from the velocity sensor 30 or a device in the vehicle and the absolute steering angle (δ) calculated by the first calculation unit 200.

Meanwhile, the apparatus for controlling an electric power steering system according to an embodiment of the present invention may further include a validity determination unit 400 determining validity of a calculated estimate of lateral acceleration. Specifically, the estimated lateral acceleration calculated by the second calculation unit 300 is compared with lateral acceleration information obtained from a lateral acceleration sensor 40 mounted on a vehicle to determine the validity of the estimated lateral acceleration. Preferably, the lateral acceleration information is transmitted to the validity determination unit 400 via a controller area network (CAN).

To provide an example of the validity determination, if the difference between the estimated lateral acceleration calculated by the second calculation unit 300 and the lateral acceleration information received via a CAN communication is equal to or less than a preset value, the validity determination unit 400 determines the estimated lateral acceleration to be valid, and an assist current value proportionate to the estimated lateral acceleration is calculated by an applied current calculation unit 500 and applied to a motor. On the other hand, if the difference between the estimated lateral acceleration and the lateral acceleration information is greater than the preset value, the calculated estimate of lateral acceleration is determined to be invalid, and a steering assist function is turned off. By this function, the electric power steering system can be stably controlled even if the estimated lateral acceleration is incorrectly calculated.

Then, the assist current value is applied to the motor of the electric power steering system based on the calculated estimate of lateral acceleration of a vehicle. Specifically, it is preferable that the assist current value be calculated proportionate to the calculated estimate of lateral acceleration, thereby controlling the electric power steering system so that a steering feeling of a driver does not become extremely heavy even if the torque sensor 10 has failed.

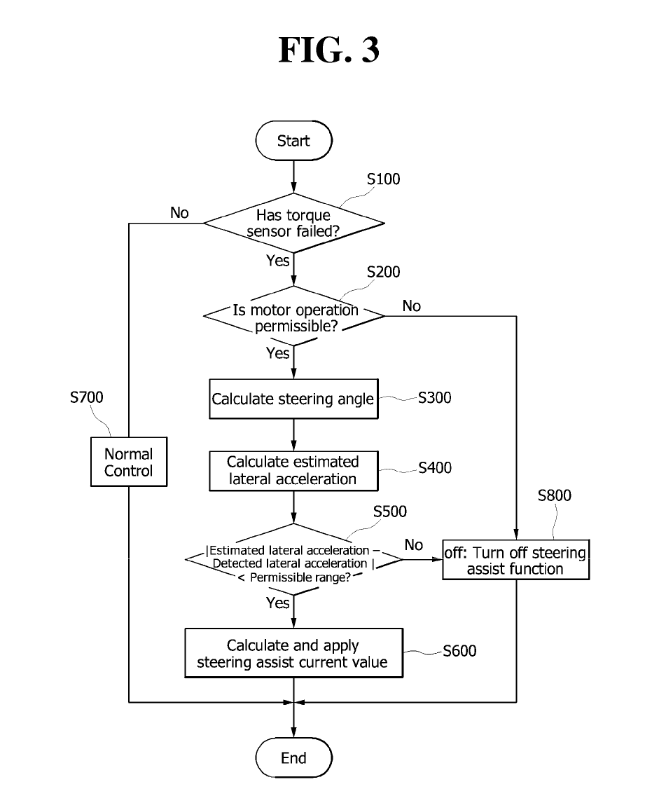

Hereinafter, a method for controlling an electric power steering system according to an embodiment of the present invention will be described with reference to FIG. 3 while detailed description of parts overlapping with the aforementioned description of the apparatus for controlling an electric power steering system according to an embodiment of the present invention will be omitted. FIG. 3 is a flow chart sequentially illustrating a method for controlling an electric power steering system according to an embodiment of the present invention.

As depicted in FIG. 3, the method for controlling an electric power steering system according to the embodiment of the present invention mainly includes detecting whether a torque sensor has failed (S100); calculating an absolute steering angle (S300); calculating an estimated lateral acceleration (S400); and calculating and applying a steering assist current value (S600).

If it is determined that the torque sensor has failed, calculating an absolute steering angle (S300) is performed, whereas normal control of an electric power steering system (S700) is performed if it is determined that the torque sensor has not failed. As stated above, in calculating an absolute steering angle (S300), the absolute steering angle is calculated based on relative angles or positions of the rotor and the stator of the motor detected by the motor position sensor 20.

Meanwhile, determining whether there is an abnormality in motor operation itself (S200) may be further included between detecting whether a torque sensor has failed (S100) and calculating an absolute steering angle (S300). That is, if an abnormality is determined to be present in the motor itself, turning off a steering assist function (S800) is performed, thereby preventing an accident caused by excessive or insufficient steering assist.

After calculating an absolute steering angle (S300), calculating an estimated lateral acceleration based on the calculated absolute steering angle and velocity of a vehicle received from a velocity sensor (S400) is performed. Particularly, the estimated lateral acceleration of the vehicle may be more easily and promptly calculated using a bicycle model.

After calculating an estimated lateral acceleration of a vehicle (S400), calculating and applying a steering assist current value (S600) is performed. Preferably, the steering assist current value is calculated to be proportionate to the calculated estimate of lateral acceleration.

Meanwhile, determining validity of a calculated estimate of lateral acceleration (S500) may be further included between calculating an estimated lateral acceleration (S400) and applying an assist current value to a motor of an electric power steering system (S600). Specifically, if the difference between the calculated estimate of lateral acceleration and a lateral acceleration obtained from a lateral acceleration sensor mounted on a vehicle is equal to or less than a preset value, the calculated estimate of lateral acceleration is determined to be valid, and calculating and applying a steering assist current value (S600) is performed. On the other hand, if the difference is greater than the preset value, the calculated estimate of lateral acceleration is determined to be invalid, and turning off a steering assist function (S800) is performed.

The embodiments described in this specification and the attached drawings merely serve to illustratively describe a part of the technical spirit included in the present invention. Accordingly, the embodiments disclosed in this specification are not for limiting the technical spirit of the present invention but for describing the same, and thus it is evident that the scope of the technical spirit of the present invention is not limited by the embodiments. Modifications and specific embodiments that can be easily made by those of ordinary skill in the art within the scope of the technical spirit included in the specification and the drawings of the present invention should all be construed as belonging to the scope of the present invention.

1. An apparatus for controlling an electric power steering system, the apparatus comprising:
a failure detection unit detecting whether a torque sensor has failed;
a first calculation unit calculating an absolute steering angle based on information detected by a motor position sensor; and
a second calculation unit calculating an estimated lateral acceleration of a vehicle based on the absolute steering angle calculated by the first calculation unit and velocity of the vehicle received from a velocity sensor, wherein, if a failure of the torque sensor is detected by the failure detection unit, an assist current value is applied to the motor based on the estimated lateral acceleration of the vehicle, and
wherein the assist current value is calculated to be proportionate to the estimated lateral acceleration calculated in the second calculation unit.

2. The apparatus of claim 1, wherein the motor position sensor detects a relative angle between a rotor and a stator of the motor.

3. The apparatus of claim 1, wherein the estimated lateral acceleration of the vehicle is calculated using a bicycle model.

4. The apparatus of claim 1, further comprising a validity determination unit comparing the estimated lateral acceleration calculated by the second calculation unit with lateral acceleration information obtained from a lateral acceleration sensor mounted on the vehicle to determine validity of the estimated lateral acceleration.

5. A method for controlling an electric power steering system, the method comprising:
detecting whether a torque sensor has failed;
if it is determined that the torque sensor has failed, calculating an absolute steering angle based on information detected by a motor position sensor of the electric power steering system;
calculating an estimated lateral acceleration of a vehicle based on the calculated absolute steering angle and velocity of the vehicle received from a velocity sensor, and
wherein the assist current value is calculated to be proportionate to the calculated lateral acceleration; and
applying an assist current value to the motor based on the estimated lateral acceleration.

6. The method of claim 5, wherein the absolute steering angle is a relative angle between a rotor and a stator of the motor.

7. The method of claim 5, wherein the estimated lateral acceleration of the vehicle is calculated using a bicycle model.

8. The method of claim 5, further comprising determining validity of the estimated lateral acceleration after the calculating of the estimated lateral acceleration, and before the applying of the assist current value to the motor.

9. The method of claim 8, wherein the estimated lateral acceleration is compared with lateral acceleration information obtained from a lateral acceleration sensor mounted on the vehicle to determine the validity of the estimated lateral acceleration.

10. The apparatus of claim 1, the second calculation unit is configured to calculate the estimated lateral acceleration by using Equation 1:
$${a}_{y} = \frac{\frac{{V}^{2}}{57.3 Lg}}{1 + \frac{{KV}^{2}}{57.3 Lg}} δ ,$$
where:
a_{y} is lateral acceleration;
δ is steering angle;
V is velocity of vehicle;
L is wheelbase;
K is under steer gradient (constant); and
G is acceleration of gravity.

11. The method of claim 5, wherein the calculating comprising calculating the estimated lateral acceleration of the vehicle by using Equation 1:
$${a}_{y} = \frac{\frac{{V}^{2}}{57.3 Lg}}{1 + \frac{{KV}^{2}}{57.3 Lg}} δ ,$$
where:
a_{y} is lateral acceleration;
δ is steering angle;
V is velocity of vehicle;
L is wheelbase;
K is under steer gradient (constant); and
G is acceleration of gravity.
